(19) United States
(12) Patent Application Publication
(10) Pub. No.: US 2009/0026673 A1
(43) Pub. Date: Jan. 29, 2009

(54) VIBRATION-DAMPENING CLIP ASSEMBLY

(76) Inventors: SYLVESTER S. CLARK, Skokie, IL (US); BRIAN R. PEEK, Mokena, IL (US); TIMOTHY D. PEARSON, Palos Hills, IL (US); CHRISTOPHER M. PANGALLO, Chicago, IL (US); CHUNNAN ZHOU, Northbrook, IL (US); JAVAD VAKIL, Morton Grove, IL (US); MARK D. BAUER, Mount Prospect, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 12/164,564

(22) Filed: Jun. 30, 2008

Related U.S. Application Data
(60) Provisional application No. 60/961,575, filed on Jul. 23, 2007.

(51) Int. Cl. F16F 9/32

(52) U.S. Cl. 267/140.11

(57) ABSTRACT

Certain embodiments of the present invention provide a vibration-dampening clip assembly configured to dampen vibrations between a tube member and a structure. The clip assembly may include a base configured to secure to a surface of the structure, at least one first spring member, and at least one second spring member. A tube retention area is defined between the at least one first spring member and the at least one second spring member. The tube retention area is suspended away from the base. The at least one first spring member and the at least one second spring member are configured to absorb vibratory energy generated by or within the tube member.

### RELATED APPLICATIONS

This application relates to and claims priority benefits from U.S. Provisional Patent Application No. 60/961,575 entitled “Vibration-Dampening Clip Assembly,” filed Jul. 23, 2007, which is hereby incorporated by reference in its entirety.

### FIELD OF EMBODIMENTS OF THE INVENTION

Embodiments of the present invention generally relate to a clip that may be used in the automotive industry, and more particularly, to a clip assembly that is configured to minimize or otherwise reduce vibration.

### BACKGROUND

Clips are used in a variety of automotive applications. For example, clips may be secured to a vehicle frame or structure and adapted to securely support tubes, pipes or the like. Fluids, such as Freon or fuel, may flow through the tubes or pipes. The fluid flowing through the tubes or pipes may produce vibratory energy that is transmitted into the tube or pipes. The vibrations may then be transmitted from the tubes or pipes into the vehicle structure, thereby producing objectionable noise and/or sensations.

Typical vibration-reducing clips are formed of two materials, a stiff material and a soft material. In particular, the soft material directly contacts the tube, while the different, stiffer material is configured to connect to the vehicle structure. The use of two materials, however, adds cost and time to the manufacturing process. For example, the soft material is typically more expensive than the stiffer material. Additionally, the process of molding the two parts and assembling them together to form the clip may provide complex and cumbersome.

### SUMMARY OF EMBODIMENTS OF THE INVENTION

Certain embodiments of the present invention provide an efficient vibration-dampening clip assembly that may be formed of a single material. The clip assembly may be formed from a single mold. That is, once the clip assembly is molded, the manufacturing process is complete such that there are no additional components formed of different materials to attach to the assembly.

Certain embodiments of the present invention provide a vibration-dampening clip assembly configured to dampen vibrations between a tube member, such as a tube, pipe, conduit or the like, and a structure. The clip assembly may include a base configured to secure to a surface of the structure, at least one first spring member, and at least one second spring member.

A tube retention area is defined between the at least one first spring member and the at least one second spring member. The tube retention area is suspended away from the base. The at least one first spring member and the at least one second spring member are configured to absorb vibratory energy generated by or within the tube member.

The spring members may be leaf springs. The first spring member(s) may include a C-shaped main body and a free end. The second spring member(s) may include a bent beam integrally connected to a hook, wherein the hook curves in opposition to the C-shaped main body. Each of the spring members may include an expanded rib, such as at a distal free end, that strengthens the spring member and may prevent over-flexing or over-collapsing.

Optionally, the first spring member(s) may be contained within a first chamber, and the second spring member(s) may be contained within a second chamber. The first and second chambers are pivotally connected by a hinge. Each spring member may include a coil spring, which may include a cupped free end configured to conform to and center an outer surface of the tube member.

The clip assembly may include a central main body extending from the base. The at least one first spring member may include two first spring members and the at least one second spring member may include two second spring members.

Each of the spring members includes a root that connects the spring member to a main structural portion of the clip assembly. The thickness and/or width of each of the spring members may increase with increased distance from the root.

The clip assembly may also include at least one flex arm configured to be flexibly compressed between the base and a surface of the structure. The flex arm(s) is configured to absorb vibrations between the base and the structure. The flex arm(s) may be angled with respect to a longitudinal axis of the base.

The clip assembly may also include a cover connected to the base through a central main body. The cover provides a rigid area to engage and urge the clip assembly into a mating area of the structure.

In general, the clip assembly may be molded as a single piece of homogenous material. That is, a single material, such as molded plastic, may be injection molded into a single casting dye or mold to form the clip assembly.

Certain embodiments of the present invention provide a vibration-dampening clip assembly that may include a base configured to secure to a surface of a structure, at least one support wall integrally connected to the base, at least one tube retaining member positioned between the at least one support wall and the base, and at least one flex arm configured to be flexibly compressed between the base and a surface of the structure. The flex arm(s) is configured to absorb vibrations between the base and the structure.

The flex arm(s) loops from a portion of the base to a portion of the at least one support wall. The flex arm(s) may be angled with respect to a longitudinal axis of the base. A width and envelope of the flex arm(s) are less than or equal to those of the base. As such, the flex arms do not increase the width, thickness or envelope of the clip assembly.

### BRIEF DESCRIPTION OF SEVERAL VIEWS OF THE DRAWINGS

FIG. 1 illustrates a side view of a vibration-dampening clip assembly, according to an embodiment of the present invention.

FIG. 2 illustrates an isometric view of a vibration-dampening clip assembly, according to an embodiment of the present invention.

FIG. 3 illustrates a top plan view of a vibration-dampening clip assembly, according to an embodiment of the present invention.

FIG. 4 illustrates an isometric view of a vibration-dampening clip assembly, according to an embodiment of the present invention.

FIG. 5 illustrates an isometric view of a vibration-dampening clip assembly, according to an embodiment of the present invention.

FIG. 6 illustrates an isometric view of a vibration-dampening clip assembly, according to an embodiment of the present invention.

FIG. 7 illustrates a bottom view of a vibration-dampening clip assembly, according to an embodiment of the present invention.

FIG. 8 illustrates an end view of a vibration-dampening clip assembly, according to an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE INVENTION

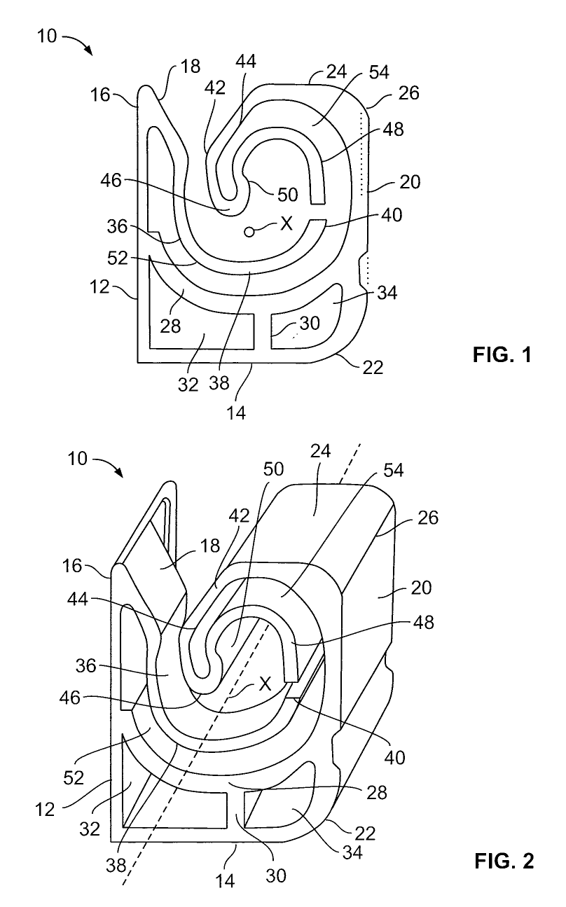

FIGS. 1 and 2 illustrate side and isometric views, respectively, of a vibration-dampening clip assembly 10, according to an embodiment of the present invention. The clip assembly 10 may be formed as a single piece from a single material, such as molded plastic. Referring to FIGS. 1 and 2, the clip assembly 10 includes a flat structure-engaging base 12 that is integrally connected to a lower support wall 14. The base 12 may include a tab, barb, clasp or the like that is configured to be securely retained within a mating hole formed in a structure, such as a vehicle frame. Optionally, the base 12 may include a mating hole and the vehicle frame may include a tab, barb, clasp or the like. Alternatively, the base 12 may be secured to the structure through fasteners, such as screws, bolts or the like.

The base 12 is generally straight having a free end 16. The free end 16 is integrally connected to an angled beam 18 that bends down toward the support wall 14. As shown in FIG. 2, in particular, the angled beam 18 may extend from only a portion of the width of the free end 16.

An outer support wall 20 upwardly extends from an end 22 of the support wall 14. The support wall 20 is generally parallel with the base 12. An inwardly-directed beam 24 extends from an end 26 of the support wall 20 toward the free end 16 of the base 12.

A support strut 28 extends from an interior surface of the base 12 to an interior surface of the support wall 20. As shown in FIGS. 1 and 2, the support strut 28 may curve or bow out toward the support wall 14. A brace 30 may extend from the support wall 14 to the support strut 28. A gap 32 may be defined between the base 12, the support strut 28, the brace 30 and the support wall 14. Also, a gap 34 may be defined between the support strut 28, the brace 30, the support wall 14 and the support wall 20.

A flexible, resilient leaf spring 36 extends from the angled beam 18. The leaf spring 36 is generally C-shaped having a curved main body 38 integrally connected to a free end 40. The leaf spring 36 extends downwardly from the angled beam 18 and inwardly curves about a central axis X of the clip assembly 10.

A flexible, resilient leaf spring 42 extends from the beam 24. The leaf spring 42 includes a flexible beam 44 downwardly extending from the beam 24. The beam 44 integrally connects to a bent beam 46, which, in turn, integrally connects to a hook 48 that curves in the opposite direction than the bent beam 46. As shown in FIGS. 1 and 2, the bent beam 46 generally curves in the same direction as the leaf spring 36, albeit with a tighter radius, while the hook 48 curves in opposition to the leaf spring 36. A tube retention area 50 is defined between the hook 48 and the leaf spring 36.

A clearance gap 52 is defined between the leaf spring 36 and the support strut 28 and base 12. Thus, the leaf spring 36 may flex and contract within the clearance gap 52. Similarly, a clearance gap 54 is defined between the leaf spring 42 and the beam 24 and the support wall 20. Thus, the leaf spring 42 may flex and contract within the clearance gap 54.

The leaf spring 36 is not directly connected to the leaf spring 42. That is, the free end 40 of the leaf spring 36 is not connected to the hook 48 of the leaf spring 42. Thus, the leaf springs 36 and 42 can flex independently with respect to one another.

In operation, the clip assembly 10 is secured to a structure, such as a vehicle frame. The base 12 secures to a portion of the structure. A tube is secured within the tube retention area 50. The leaf springs 36 and 42 flex open in order to receive and retain the tube and then securely flex back to a retaining position around the tube The hook 48 of the leaf spring 42 conforms around a circumferential portion of the tube, while the opposing main body 38 of the leaf spring 36 conforms around an opposite circumferential portion of the tube.

The leaf springs 36 and 42 suspend the tube in the tube retention area 50 away from the base 12. That is the leaf spring 36 and 42 ensure that the tube does not abut portions of the clip assembly 10 that directly abut the structure to which the clip assembly 10 is attached.

Fluid flow within the tube may cause the tube to vibrate. The vibratory energy is dampened by the leaf springs 36 and 42. That is, the leaf springs 36 and 42 act as shocks that absorb the vibratory energy and flex and contract in response thereto. Because the leaf springs 36 and 42 absorb the vibratory energy, the vibrations are not transmitted to the support walls 14, 20 or the base 12. Thus, the vibrations are not transmitted to the structure to which the clip assembly 10 is attached.

When a tube secured by the leaf springs 36 and 42 vibrates, the vibration will move only the portion of the leaf springs 36 and 42 that are easily flexible. That is, the portions of the leaf springs 36 and 42 that contact the tube flex and absorb the vibratory energy. The vibratory energy is absorbed before it can reach the roots of the leaf springs 36 and 42, i.e., those portions connected to the beams 18 and 24. As a result, the spring constant may be small and adequately controlled by the portions of the leaf springs 36 and 42 that contact the tube, and not affected by the structural main portion of the clip assembly 10, or the roots of the leaf springs 36 and 42.

The spring constant of the leaf springs 36 and 42 may vary depending on the length, thickness and width of the leaf springs 36 and 42. The shorter, wider and thicker the leaf spring, the higher the spring constant.

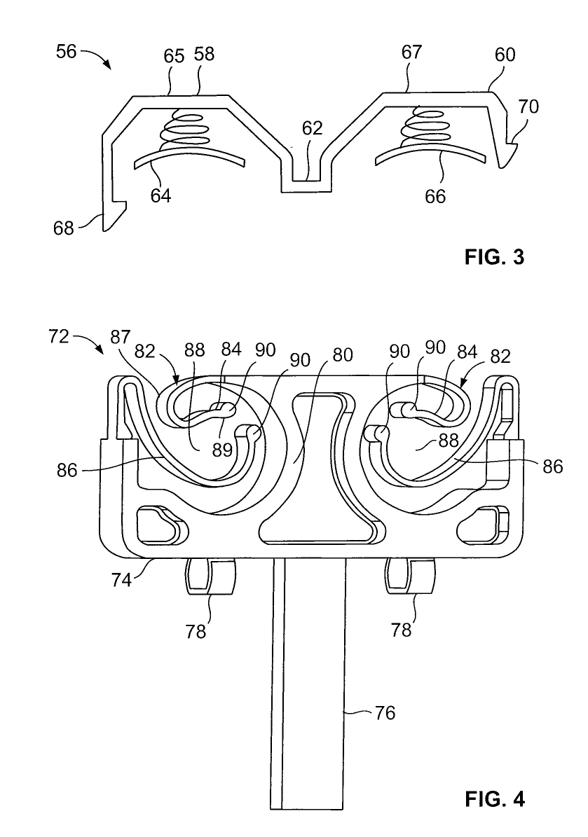

FIG. 3 illustrates a top plan view of a vibration-dampening clip assembly 56, according to an embodiment of the present invention. The clip assembly 56 includes opposed chambers 58 and 60 connected to one another through a hinge 62. The chambers 58 and 60 pivot into open and closed positions with respect to one another about the hinge 62. As shown in FIG. 3, the clip assembly 56 is in the open position. A coil spring 64 extends into the chamber 58 from a main wall 65. Similarly, a coil spring 66 extends into the chamber 60 from a main wall 67. The free ends of the coil springs 64 and 66 may be cupped or curved to engage an outer surface of a tube and ensure that the tube is centered on the springs 64 and 66.

A tube is positioned in one of the chambers 58 or 60 such that it directly abuts the coil spring 64 or 66, respectively. The chambers 58 and 60 are then pivoted into a closed position about the hinge 62. The chamber 58 includes a latch 68 that is received and retained by a reciprocal latch structure 70 of the chamber 60. Thus, the tube is secured between the coil springs 64 and 66 of the chambers 58 and 60, respectively. The coil springs 64 and 66 absorb vibratory energy generated by the tube. Thus, the vibratory energy is not transmitted to the structure attached to the clip assembly 56.

FIG. 4 illustrates an isometric view of a vibration-dampening clip assembly 72, according to an embodiment of the present invention. The clip assembly 72 includes a base 74 having a stud 76 and tabs 78 extending downwardly therefrom. The stud 76 and tabs 78 may be used to securely mate the clip assembly 72 into reciprocal features formed in a structure.

A central main body 80 extends upwardly from the base 74. Vibration-dampening retaining clips 82 are formed on either side of the central main body 80. Each retaining clip 82 includes opposed leaf springs 84 and 86 defining tube retention areas 88 therebetween. The leaf spring 84 includes a bent beam 87 having a larger radius (and therefore gentler curve) than that described above with respect to FIGS. 1 and 2. Further, the hook 89 connected to the bent beam 87 is flatter than that described above with respect to FIGS. 1 and 2.

Tubes, pipes or the like may be positioned within the tube retention areas 88 and flexibly secured by the opposed leaf springs 84 and 86. Free ends 90 of each leaf spring 86 and 88 may be expanded. For example, the free ends 90 may be shaped as expanded ribs. The expanded free ends 90 ensure that the leaf springs 86 and 88 do not over-flex or collapse.

Thus, the clip assembly 72 may secure two tubes to a structure. Optionally, the clip assembly 72 may include more retaining clips 82 than those shown. As shown in FIG. 4, the leaf springs 86 and 88 are configured to suspend the tubes, pipes or the like away from the base 74. As discussed above with respect to FIGS. 1 and 2, the leaf springs 86 and 88 absorb vibratory energy generated by the tubes, thereby preventing that energy from being transmitted into the structure to which the clip assembly 72 is attached.

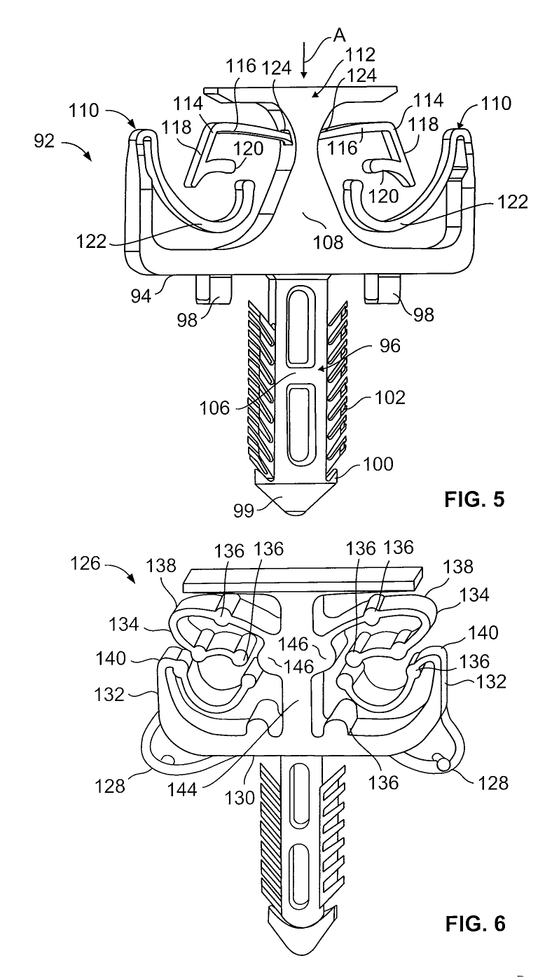

FIG. 5 illustrates an isometric view of a vibration-dampening clip assembly 92, according to an embodiment of the present invention. The clip assembly 92 includes a base 94 having a stud 96 and tabs 98 extending downwardly therefrom. The stud 96 may include a beveled nose having a locking ledge 100. Further, a plurality of angled spurs 102 may extend from the shaft 106 of the stud 96. The beveled nose 99 and spurs 102 allow the stud 96 to be securely inserted into a reciprocal hole of a structure, but resist removal from the reciprocal hole.

A central main body 108 extends from the base 94. Vibration-dampening retaining clips 110 are formed on either side of the central main body 108. An actuatable cover 112 is integrally connected to the central main body 108 and is configured to allow an operator to push the clip assembly 92 into a mating hole of a structure. That is, an operator may engage the cover 112, which securely connects to the central main body 108, and push the clip assembly 92 into a mating hole in the direction of arrow A. Further, the cover 112 limits the range of motion over which leaf springs 114 may bend and flex, thereby preventing tubes within the retaining clips 110 from ejecting therefrom.

As shown in FIG. 5, the leaf springs 114 extend laterally from the central main body 108. At least portions of the leaf springs 114 are underneath the cover 112. Each leaf spring 114 includes a straight beam 116 that integrally connects to an outwardly angled beam 118, which is, in turn, integrally connected to a tube-conforming beam 120. Leaf springs 122 that are opposed to the tube-conforming beams 120 are shaped similar to those described above.

The thickness of the leaf springs 114 may be the same or less than that of the leaf springs 122. Indeed, the thickness of the leaf springs 114 may be relatively small over the entire length thereof, even at the points (i.e., roots 124) where they connect to the central main body 108. As such, the spring constant of each leaf spring 114 may be small.

Both leaf springs 114 and 122 may include reduced widths and/or thicknesses. Further, the width and/or thickness of each leaf spring 114 and 122 may increase with increased distance from their respective roots. Because the spring constant of each leaf spring 114 and 122 is generally determined at the point where it connects to the walls of the clip assembly 92, the thinner roots provide smaller spring constants, while the increased thickness of the leaf springs 114 and 122 proximate their free ends provides strength and robustness to the leaf springs 114 and 122. The thickness of all the leaf springs discussed above with respect to FIGS. 1-2 and 4 may be reduced in such manner to provide a smaller spring constant, while maintaining strength and robustness.

FIGS. 6, 7 and 8 illustrate isometric, bottom and end views, respectively of a vibration-dampening clip assembly 126, according to an embodiment of the present invention. The clip assembly 126 is similar to those described above with respect to FIGS. 4 and 5. The clip assembly 126 includes flex arms 128 downwardly extending from a base 130. As shown in FIG. 6, each flex arm 128 may be a tubular beam having one end attached to a lateral wall 132 and another end attached to the base 130. Each flex arm 128 bows out from the lateral wall 132 and loops back in toward to a point where it attaches to the base 130.

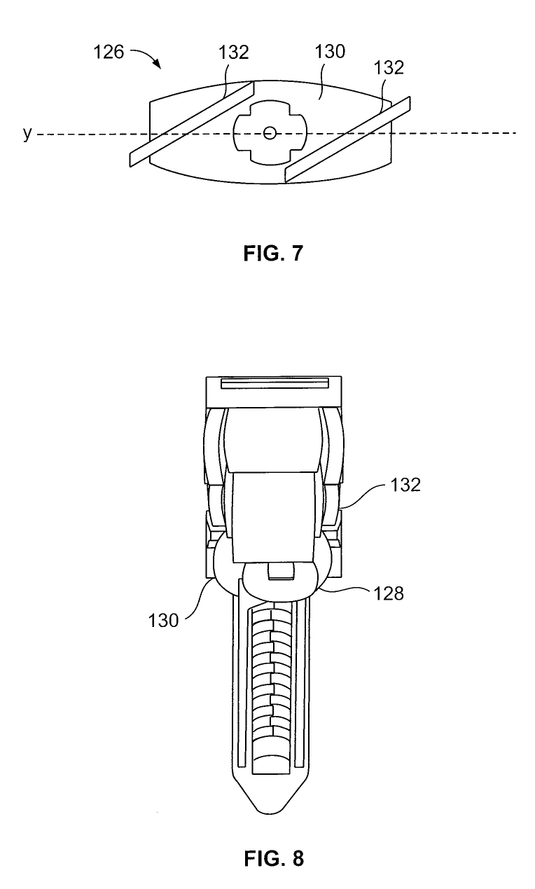

As shown in FIG. 7, the flex arms 128 are angled with respect to an axis y of the clip assembly 126. That is, the flex arms 128 are not aligned with the axis y. While the flex arms 128 may be parallel with one another, the flex arms may not be parallel with the axis y. The angled nature of the flex arms 128 ensures that they contact a structural surface along a plurality of axes. Thus, the flex arms 128 are configured to absorb vibrations over a wider range of directions. Alternatively, the flex arms 128 may be aligned with and/or parallel with the axis y.

In general, the clip assembly 126 including the flex arms 128 is more compact than previous clips that provide vibration damping between the clip and a structure. For instance, as shown in FIG. 7, the flex arms 128 generally do not increase the envelope of the clip assembly 126. Further, as shown in FIG. 8, the flex arms 128 do not increase the width of the clip assembly 126. Therefore, the clip assembly 126 is generally no more obtrusive than a clip assembly without the flex arms 128.

In operation, the flex arms 128 are resilient, flexible members that are configured to absorb vibratory energy between the base 130 and a structure attached to the clip assembly 126. Thus, the clip assembly 126 is configured to absorb vibrations generated by tubes within the dampening clips 134 and also any excess vibrations that are transmitted into the base 130 or from the structure that is attached to the base. At least one flex arm 128 may be used with any of the embodiments discussed above with respect to FIGS. 1-5.

As shown in FIG. 6, the dampening clips 134 may include a plurality of expanded ribs 136 on the leaf springs 138 and 140. Further, the base 130 may include ribs 142 proximate a central wall 144, which may also include ribs 146 proximate a union of the central wall 144 and the leaf springs 138. The ribs 136, 142 and 146 provide added strength and robustness to the clip assembly 126.

It has been found that the embodiments described above provide an efficient vibration-dampening clip assembly. Additionally, because the embodiments may be formed from a single material using a one-step molding process, the embodiments provide an inexpensive and easy to manufacture clip assembly.

Embodiments of the present invention provide a clip assembly that absorbs and dampens vibratory energy generated by a tube. Thus, the vibrations are not transmitted from the tube into a base of the clip assembly. Additionally, embodiments of the present invention provide a clip assembly that absorbs and dampens vibrations from a base with respect to a structure, and vice versa.

While various spatial and directional terms, such as top, bottom, lower, mid, lateral, horizontal, vertical, front and the like may used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A vibration-dampening clip assembly configured to dampen vibrations between a tube member and a structure, the clip assembly comprising:
a base configured to secure to a surface of the structure;
at least one first spring member; and
at least one second spring member, a tube retention area being defined between said at least one first spring member and said at least one second spring member, said tube retention area being suspended away from said base, wherein said at least one first spring member and said at least one second spring member are configured to absorb vibratory energy generated by or within the tube member.

2. The clip assembly of claim 1, wherein said at least one first spring member and said at least second spring member comprise leaf springs

3. The clip assembly of claim 2, wherein said at least one first spring member comprises a C-shaped main body and a free end.

4. The clip assembly of claim 3, wherein said at least one second spring member comprises a bent beam integrally connected to a hook, wherein said hook curves in opposition to said C-shaped main body.

5. The clip assembly of claim 1, said at least one first spring member being contained within a first chamber, said at least one second spring member being contained within a second chamber, said first and second chamber being pivotally connected by a hinge, and wherein each of said at least one first spring member and said at least one second spring member comprises a coil spring.

6. The clip assembly of claim 5, wherein said coil spring comprises a cupped free end configured to conform to and center an outer surface of the tube member.

7. The clip assembly of claim 1, comprising a central main body extending from said base, wherein said at least one first spring member comprises two first spring members and said at least one second spring member comprises two second spring members.

8. The clip assembly of claim 1, wherein each of said at least one first spring member and said at least one second spring members comprises an expanded rib.

9. The clip assembly of claim 1, wherein each of said at least one first spring member and said at least one spring member comprises a root, wherein one or both of a thickness and/or width of each of said at least one first spring member and said at least one second spring member increases with increased distance from said root.

10. The clip assembly of claim 1, comprising at least one flex arm configured to be flexibly compressed between said base and a surface of the structure, said at least one flex arm configured to absorb vibrations between said base and the structure.

11. The clip assembly of claim 10, wherein said at least one flex arm is angled with respect to a longitudinal axis of said base.

12. The clip assembly of claim 1, comprising a cover connected to said base through a central main body, said cover providing a rigid area to engage and urge the clip assembly into a mating area of the structure.

13. The clip assembly of claim 1, wherein the clip assembly is molded as a single piece of homogenous material.

14. A vibration-dampening clip assembly configured to dampen vibrations between a tube member and a structure, the clip assembly comprising:
a base configured to secure to a surface of the structure;
at least one support wall integrally connected to said base;
at least one tube retaining member positioned between said base and said at least one support wall; and
at least one flex arm configured to be flexibly compressed between said base and a surface of the structure, said at least one flex arm configured to absorb vibrations between said base and the structure.

15. The clip assembly of claim 14, wherein said at least one flex arm loops from a portion of said base to a portion of said at least one support wall.

16. The clip assembly of claim 14, wherein said at least one flex arm is angled with respect to a longitudinal axis of said base.

17. The clip assembly of claim 14, wherein a width and envelope of said at least one flex arm are less than or equal to those of said base.

18. A vibration-dampening clip assembly configured to dampen vibrations between a tube member and a structure, the clip assembly comprising:
a base configured to secure to a surface of the structure;
at least one first leaf spring comprising a C-shaped main body and a free end; and
at least one second leaf spring comprising a bent beam integrally connected to a hook, wherein said hook curves in opposition to said at C-shaped main body, a tube retention area being defined between said at least one first leaf spring and said at least one second leaf spring, said tube retention area being suspended away from said base, wherein said at least one first leaf spring and said at least one second leaf spring are configured to absorb vibratory energy generated by or within the tube member,
wherein each of said at least one first leaf spring and said at least one second leaf spring comprises a root, wherein one or both of a thickness and/or width of each of said at least one first leaf spring and said at least one second leaf spring increases with increased distance from said root; and
at least one flex arm configured to be flexibly compressed between said base and a surface of the structure, said at least one flex arm configured to absorb vibrations between said base and the structure.

19. The clip assembly of claim 18, further comprising a cover connected to said base through a central main body, said cover providing a rigid area to engage and urge the clip assembly into a mating area of the structure.

20. The clip assembly of claim 19, wherein the clip assembly is molded as a single piece of homogenous material.
